(19) United States
(12) Patent Application Publication
(10) Pub. No.: US 2011/0154815 A1
(43) Pub. Date: Jun. 30, 2011

(54) SWING MOTOR CONTROL METHOD IN OPEN CENTER TYPE HYDRAULIC SYSTEM FOR EXCAVATOR

(75) Inventor: Chun Han LEE, Gimhae-si (KR)

(73) Assignee: VOLVO CONSTRUCTION EQUIPMENT HOLDING SWEDEN AB

(21) Appl. No.: 12/982,072

(22) Filed: Dec. 30, 2010

(30) Foreign Application Priority Data
Dec. 30, 2009 (KR) 10-2009-133518

(51) Int. Cl. F15B 13/042

(52) U.S. Cl. 60/459

(57) ABSTRACT

A swing motor control method in an open center type hydraulic system for a hydraulic excavator is provided, which can adjust the speed of a swing motor so that a swing device and a working device harmonize with each other according to a discharge pressure of a hydraulic pump during a multifunctional work of the working device and the swing device. The swing motor control method in an open center type hydraulic system for an excavator including first and second hydraulic pumps, a swing motor, a working device actuator including a boom or arm actuator, a working device control valve controlling a start, a stop, and a direction change of the working device actuator, a discharge pressure sensor sensing the discharge pressure of the second hydraulic pump, and a swing motor controller controlling a speed of the swing motor in accordance with the pressure detected by the discharge pressure sensor, includes controlling the speed of the swing motor during a multifunctional operation of the swing device and the working device, comparing the pressure detected by the hydraulic pump discharge pressure sensor with a preset pump discharge pressure, and controlling a limiting speed of the swing motor in accordance with the result of comparison.

### CROSS-REFERENCE TO RELATED APPLICATION

This application is based on and claims priority from Korean Patent Application No. 10-2009-133518, filed on Dec. 30, 2009 in the Korean Intellectual Property Office, the disclosure of which is incorporated herein in its entirety by reference.

### BACKGROUND OF THE INVENTION

1. Field of the invention

The present invention relates to a swing motor control method in an open center type hydraulic system for an excavator. More particularly, the present invention relates to an improved swing motor control method in an open center type hydraulic system for a hydraulic excavator, which can adjust the speed of a swing motor that is electrically controlled so as to harmonize with a working device in accordance with a discharge pressure of a hydraulic pump during a multifunctional work of the working device and a swing device.

2. Description of the Prior Art

Generally, in a hydraulic system for an excavator, with the development of an electro-hydraulic system, many swing control devices through electro-hydraulic control type valves have been introduced. Recently, with the development of a hydraulic type using an electric motor as a main power, a swing device of the existing hydraulic excavator may be replaced by an electric motor, or hydraulic and electric motors may be used together. In this case, a swing work of an excavator is controlled by a controller that is constructed independently of the existing hydraulic system.

FIG. 1 is a schematic diagram illustrating a closed center type hydraulic system for an excavator in the related art, and FIG. 2 is a schematic diagram illustrating an open center type hydraulic system for an excavator in the related art. As illustrated in FIG. 1, in the case of using the closed center type hydraulic system, hydraulic fluid that is discharged from a first hydraulic pump 1 is controlled through an electro-hydraulic control valve 5 in order to control a swing motor 3, and hydraulic fluid that is discharged from a second hydraulic pump 2 is independently controlled through a working device control valve 7 in order to drive an actuator 4 for a boom, an arm, or a bucket as a working device.

However, as illustrated in FIG. 2, in the case of the open center type hydraulic system, since the swing motor 3 and the actuator 4 of the working device are mutually affected by fluid pressure during the multifunctional work, it is required to appropriately control the swing motor 3 that requires a relatively large load. That is, during the swing operation, even if the fluid pressure of the first pump 1 is used, the actuator 4 of the working device uses both the fluid pressure of the first hydraulic pump 1 and the fluid pressure of the second fluid pressure 2 through a confluence line 9.

In this case, the swing motor 3 is unable to output the maximum torque, and this is because loads of the respective working devices are smaller than the initial load of the swing motor 3. The multifunctional operation is performed as the torque of the swing motor 3 is limited below the load of the working device.

Accordingly, the torque of the swing motor 3 is lowered during a multifunctional operation or a multifunctional work in which the swing operation and the working device operation are simultaneously performed rather than the single operation, and thus there is a problem that the swing device and the working device are unable to be appropriately controlled. Also, in the hydraulic system in the related art, diverse solution means have been proposed to control a swing operation to harmonize with a working device operation, and as one example, U.S. Pat. No. 6,708,787, which was assigned to Komatsu Ltd. in Japan, discloses a hybrid hydraulic system.

However, this hybrid hydraulic system is configured so that one variable hydraulic pump is controlled by an electronic regulator, and in order to control an output of the hydraulic pump during a multifunctional work, an inclination angle element of the swash plate is essentially required. Also, the actual discharge pressure of the hydraulic system cannot be sensed on the discharge side of the hydraulic pump, and thus an appropriate swing control may not be performed.

### SUMMARY OF THE INVENTION

Accordingly, the present invention has been made to solve the above-mentioned problems occurring in the prior art while advantages achieved by the prior art are maintained intact.

One subject to be achieved by the present invention is to provide a swing motor control method in an open center type hydraulic system for an excavator, which can adjust the speed of a swing motor based on a discharge pressure of a hydraulic pump that is detected on the discharge side of the hydraulic pump during a multifunctional operation of a swing device and a working device.

In one aspect of the present invention, there is provided a swing motor control method in an open center type hydraulic system for an excavator including a first hydraulic pump, a second hydraulic pump, a swing motor, a working device actuator including a boom or arm actuator, a working device control valve installed between the second hydraulic pump and the working device actuator to control a start, a stop, and a direction change of the working device actuator, a discharge pressure sensor installed on a supply line that is formed between the second hydraulic pump and the working device control valve to sense the discharge pressure of the second hydraulic pump, and a swing motor controller connected to the swing motor to control a speed of the swing motor in accordance with the pressure detected by the discharge pressure sensor, which includes the steps of controlling the speed of the swing motor during a multifunctional operation of the swing device and the working device; comparing the pressure detected by the hydraulic pump discharge pressure sensor with a preset pump discharge pressure; and controlling a limiting speed of the swing motor in accordance with the result of comparing the pressure detected by the hydraulic pump discharge pressure sensor with the preset pump discharge pressure.

In the swing motor control method according to an embodiment of the present invention, the swing motor is driven by electricity, and the preset pump discharge pressure is preset in accordance with the driving of the boom or arm actuator and a traveling working device.

According to the swing motor control method in an open center type hydraulic system for an excavator according to an embodiment of the present invention, since the discharge pressure of the hydraulic pump is detected on the discharge side of the hydraulic pump in the open center type hydraulic system, design elements for connecting to the inclination angle element of the swash plate of the hydraulic pump is not required, unlike the hydraulic system in the related art, and thus the hydraulic system can be constructed with a compact size. Also, the working device and the swing device can harmonize with each other during the multifunctional work of the swing device and the working device through a control of the speed of the swing motor based on the fluid pressure discharged from the second hydraulic pump.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic diagram illustrating a closed center type hydraulic system for an excavator in the related art;

FIG. 2 is a schematic diagram illustrating an open center type hydraulic system for an excavator in the related art;

FIG. 3 is a flowchart illustrating a swing motor control method in an open center type hydraulic system for a vehicle according to an embodiment of the present invention; and

FIG. 4 is a schematic view illustrating a hydraulic system that controls a swing motor by a swing motor control method in an open center type hydraulic system for a vehicle according to an embodiment of the present invention.

### DETAILED DESCRIPTION OF THE PREFERRED EMBODIMENTS

Hereinafter, preferred embodiments of the present invention will be described with reference to the accompanying drawings. The matters defined in the description, such as the detailed construction and elements, are nothing but specific details provided to assist those of ordinary skill in the art in a comprehensive understanding of the invention, and thus the present invention is not limited thereto. The same drawing reference numerals are used for the same elements across various figures.

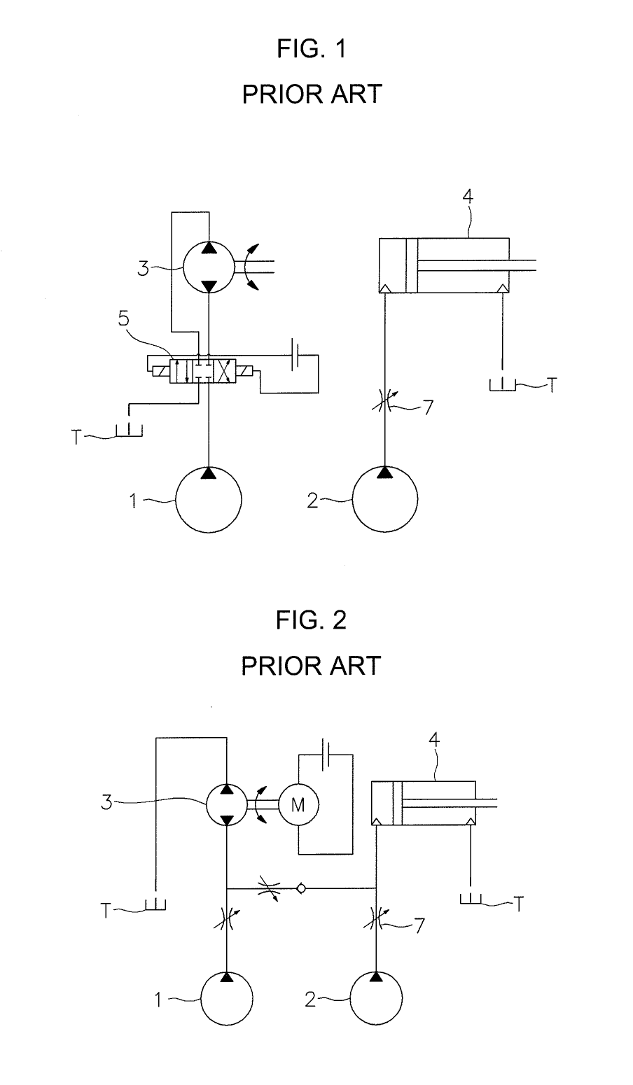

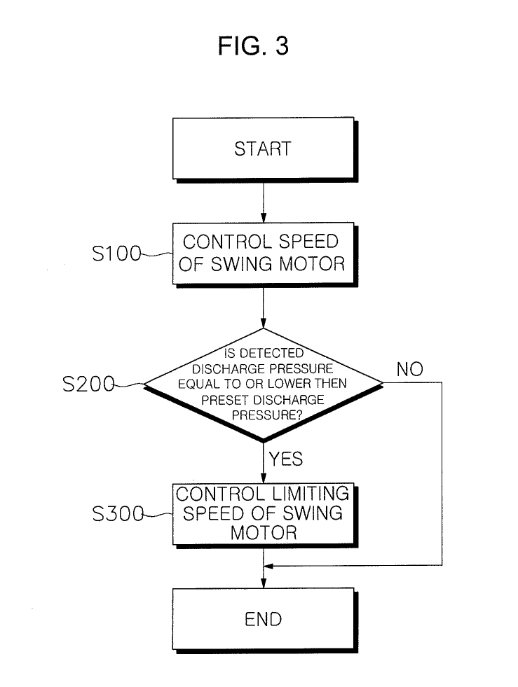

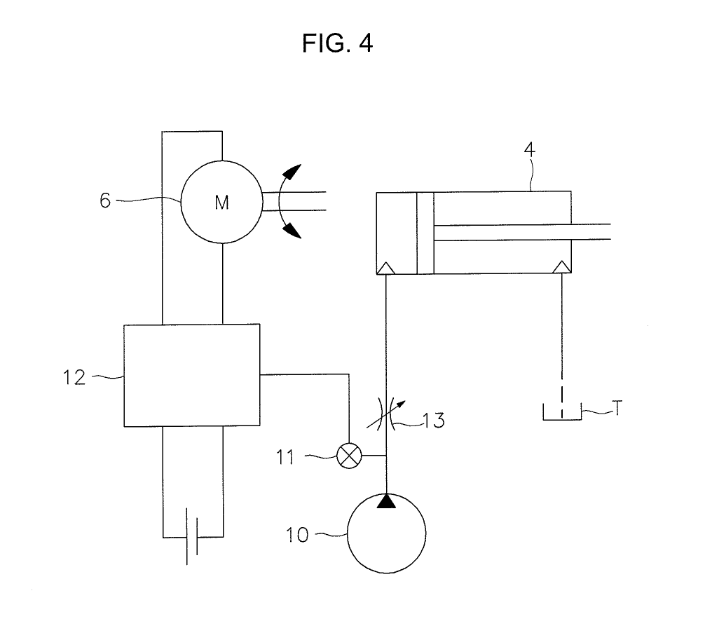

FIG. 1 is a schematic diagram illustrating a closed center type hydraulic system for an excavator in the related art, and FIG. 2 is a schematic diagram illustrating an open center type hydraulic system for an excavator in the related art. FIG. 3 is a flowchart illustrating a swing motor control method in an open center type hydraulic system for a vehicle according to an embodiment of the present invention, and FIG. 4 is a schematic view illustrating a hydraulic system that controls a swing motor by a swing motor control method in an open center type hydraulic system for a vehicle according to an embodiment of the present invention.

In the following description of the present invention, reference numerals “1” and “2” denote a first hydraulic pump and a second hydraulic pump, respectively, “4” denotes a working device actuator including a boom or an arm, and “7” denotes a working device control valve.

According to an embodiment of the present invention, a swing motor control method in an open center type hydraulic system for an excavator including a first hydraulic pump 1, a second hydraulic pump 10, a swing motor 6, a working device actuator 4 including a boom or arm actuator, a working device control valve 13 installed between the second hydraulic pump 2 and the working device actuator 4 to control a start, a stop, and a direction change of the working device actuator 4, a hydraulic pump discharge pressure sensor 11 installed on a supply line that is formed between the second hydraulic pump 10 and the working device control valve 13 to sense the discharge pressure of the second hydraulic pump 10, and a swing motor controller 12 connected to the swing motor 6 to control a speed of the swing motor 6 in accordance with the pressure detected by the hydraulic pump discharge pressure sensor 11, which includes the steps of controlling the speed of the swing motor 6 during a multifunctional operation of the swing device and the working device (S100); comparing the pressure detected by the hydraulic pump discharge pressure sensor 11 with a preset pump discharge pressure Pref (S200); and controlling a limiting speed V of the swing motor in accordance with the result of comparing the pressure detected by the hydraulic pump discharge pressure sensor 11 with the preset pump discharge pressure Pref (S300).

In the swing motor control method in an open center type hydraulic system for an excavator according to an embodiment of the present invention, the swing motor 6 is driven by electricity, and the preset pump discharge pressure Pref is preset in accordance with the driving of the boom or arm actuator and a traveling working device.

In an embodiment of the present invention, an unexplained reference numeral “T” denotes a hydraulic tank to which hydraulic fluid returns.

Hereinafter, the swing motor control method in an open center type hydraulic system for an excavator according to an embodiment of the present invention will be described in detail.

In the same manner as the hydraulic system in the related art, a start, a stop, and a direction change of the working device actuator 4, for example, a boom actuator or an arm actuator, are controlled by the working device control valve 13 that is installed on the supply line formed between the second hydraulic pump 10 and the working device control valve 13.

In the open center type hydraulic system for an excavator according to an embodiment of the present invention, during the driving of the boom actuator or the arm actuator, the hydraulic pump discharge pressure sensor installed between the working device control valve 13 and the second hydraulic pump 10 senses the discharge pressure, and a sensed signal is applied to the controller 12.

Typically, during a single swing operation, the swing motor 6 is controlled by the controller 12, and during a multifunctional operation of the swing device and the working device, the controller 12 compares the sensed discharge pressure of the second hydraulic pump 10 with the pump discharge pressure Pref preset according to a load of the working device.

In particular, during the multifunctional operation of the swing device and the working device, the controller 12 controls the speed of the swing motor 6 through the steps of controlling the speed of the swing motor 6 during a multifunctional operation of the swing device and the working device (S100), comparing the pressure detected by the hydraulic pump discharge pressure sensor 11 with the preset pump discharge pressure Pref (S200), and controlling the limiting speed V of the swing motor in accordance with the result of comparing the pressure detected by the hydraulic pump discharge pressure sensor 11 with the preset pump discharge pressure Pref (S300).

That is, in order to limit the speed of the swing motor 6 during the multifunctional operation, the controller 12 that takes part in the swing operation measures only the pressure on the discharge side of the hydraulic pump even if the inclination angle of the swash plate of the second hydraulic pump 10 is changed.

The controller 12 calculates the required level of load of the boom or arm actuator and the traveling device, which generates during the multifunctional operation in accordance with the discharge pressure detected through the above-described measurement, and determines the limiting speed V by limiting the torque of the swing motor based on the result of calculation.

If the pump discharge pressure detected on the discharge side of the second hydraulic pump 10 during the multifunctional operation is equal to or lower than the preset pump discharge pressure Pref, the controller 12 controls the speed of the swing motor 6 that is driven by electricity in the same manner as the single swing operation.

On the other hand, according to an embodiment of the present invention, it is appropriate that the limiting speed V of the swing motor during the multifunctional operation of the swing device and the boom is controlled to be relatively lower than the speed during the multifunctional operation of the swing device and the arm. However, various modifications may be made in accordance with the conditions on the construction spot, work environments, product specification, and the like.

Although preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A swing motor control method in an open center type hydraulic system for an excavator including a first hydraulic pump, a second hydraulic pump, a swing motor, a working device actuator including a boom or arm actuator, a working device control valve installed between the second hydraulic pump and the working device actuator to control a start, a stop, and a direction change of the working device actuator, a discharge pressure sensor installed on a supply line that is formed between the second hydraulic pump and the working device control valve to sense the discharge pressure of the second hydraulic pump, and a swing motor controller connected to the swing motor to control a speed of the swing motor in accordance with the pressure detected by the discharge pressure sensor, the swing motor control method comprising the steps of:
controlling the speed of the swing motor during a multifunctional operation of the swing device and the working device;
comparing the pressure detected by the hydraulic pump discharge pressure sensor with a preset pump discharge pressure; and
controlling a limiting speed of the swing motor in accordance with the result of comparison of the pressure detected by the hydraulic pump discharge pressure sensor with the preset pump discharge pressure.

2. The swing motor control method according to claim 1, wherein the swing motor is driven by electricity, and the preset pump discharge pressure is preset in accordance with the driving of the boom or arm actuator and a traveling working device.
